(19) United States
(12) Patent Application Publication
(10) Pub. No.: US 2022/0188829 A1
(43) Pub. Date: Jun. 16, 2022

(54) TRANSACTION VERIFICATION OF DISTRIBUTED LEDGERS

(71) Applicant: BRITISH TELECOMMUNICATIONS PUBLIC LIMITED COMPANY, LONDON (GB)

(72) Inventor: Evandro PIOLI MORO, London (GB)

(21) Appl. No.: 17/310,967

(22) PCT Filed: Feb. 27, 2020
(86) PCT No.: PCT/EP2020/055207

§ 371 Date: Sep. 2, 2021

(30) Foreign Application Priority Data
Mar. 6, 2019 (EP) 19161132.6

(51) Int. Cl. G06Q 20/40; G06Q 20/06; G06N 7/00; H04L 67/1095

(52) U.S. Cl. CPC G06Q 20/4016; G06Q 20/065; G06Q 2220/00; H04L 67/1095; G06N 7/005

(57) ABSTRACT

A distributed ledger process, such as a blockchain system, posts transactions between nodes in a network to a distributed ledger supported by the network. Transaction data generated in respect of a data node are validated by comparison with a data source of permitted transaction data types to be generated in respect of the data node, and the transaction data is posted to the distributed ledger only if it is identified as permitted. Checks can include access permissions, expected periodicity of measurement, whether a measure is within an expected range, and packet size.

### PRIORITY CLAIM

The present application is a National Phase entry of PCT Application No. PCT/EP2020/055207, filed Feb. 27, 2020, which claims priority from EP Patent Application No. 19161132.6, filed Mar. 6, 2019, each of which is hereby fully incorporated herein by reference.

### FIELD

The present disclosure relates generally to transaction verification of distributed ledgers.

### BACKGROUND

Distributed ledger architectures may encompass database structures together with the distributed transactions ledger. A distributed database can be built within the distributed ledger, via smart contracts (although it can result in a very heavy and inefficient architecture); or superimposed on its architecture, in which the database is distributed amongst the nodes, and the ledger holds the history of transactions as well as the pointers to the data, to guarantee its integrity. The distributed ledger architecture was initially designed to enhance system scalability while keeping the light weight required by some devices, which is especially important for Internet of Things (IoT) architectures. Data is still stored at the nodes, but it can now be shared between various nodes; as a local copy of the entire database is not required to be stored locally by all devices.

### SUMMARY

The present disclosure may be implemented using blockchain technology, which can enable secure and immutable networking amongst parties that have not established a trust relationship with each other. It is fully decentralized, in the sense that no central authority controls the network to an extent that would give that authority the capacity to own a significant amount of the network. However, alternative distributed ledger architectures, that are similar but not akin to the traditional blockchain architectures, such as directed acyclic graphs (DAG) structures may be used instead. DAGs are built for scalability and quick execution. These mechanisms replace the block structures, where the headers and fields hinder performance, in detriment to a “bubbles” structure where only transactions are included. It involves a first peer validating two other transactions in order to allow the first to send a transaction. Peers also have to verify transactions in order to remain in the network. The “Tangle” is an example of a DAG distributed ledger architecture. These DAGs also can include more than one layer, for instance having a distributed database on top, and transactions pointing to data chunks.

Blockchain technology can be used to manage distributed ledgers. Such blockchain technologies are systems where a chain of blocks containing a list of transaction is shared amongst all the parties of a network. Such transactions would include information about changes on the network and the state of the peers between which the transactions take place, and consist of sending data to a party. The data may represent any numerical value, such as physical properties, or may represent monetary value or “coins”. Such chains are immutable, as any change on a block or transaction causes a substantial change to all precedent blocks, being therefore easily spotted and thus rejected by peers. This architecture can easily detect and prevent attacks on the data and state stored at the blocks.

The parties on the network, or more specifically the devices holding full copies of the chain of blocks, are called nodes. The nodes are able to exchange tokens on the blockchain via transactions. These transactions are added to the blocks by a single (trusted) node, called a sealer node or a block sealer, which is determined by the network algorithm via a process called consensus algorithm. Because this consensus algorithm is decentralized and fair, the nodes can trust the sealer node to add all the transactions sent by its peer fully to the next block. Normally, each block will be sealed by a different node on each turn, and the fairer the network is, the less repetition and predictability of sealing nodes there will be.

A block is created every few seconds or minutes on the blockchain and the time between the creation of two consecutive blocks is called the block period (x). The block period is determined by the consensus network of the network, and depends on the consensus algorithm set and its characteristics. On the most-used consensus protocol, known as Proof of Work (PoW), this block period is determined by the time taken for any node on the network to solve a mathematical puzzle, and in consequence is variable but controllable. There exist other protocols that will set the block period to a fixed period of time and others that will only create blocks when a transaction, or transactions, arrives. This will then start the transaction verification period and afterwards create a block.

Although a transaction can be sent by a node at any time, it will only be processed and written to the blockchain when the next block is sealed, and this comes after the validation process is completed. This means it can take up to one block period for the transaction to be included onto the blockchain. This period in which a transaction waits to be processed and written to the blockchain will be herein called the “inter-block period”. After a transaction is sent by one of the accounts, the network starts a validation process which begins with verifying the existence of the sender account, and whether its signature is valid. Later, the validation entails fees calculations, with fees collection by the sealer node in order to execute the transaction. Lastly, the verification of the address of the receiving account takes place. If the transaction fails, for any of the reasons above, the blockchain state is returned to the previous state before the transaction was sent, and any fees are not restored to the sending account, once the sealer has indeed spent computing power on this failed transaction. If the transaction succeeds on the verification processes above, it gets written into the next block and the actions described within it change the blockchain state (accounts balances, data posting/deletion, amongst others). No verification at the data level is carried out at this validation process.

Some blockchain architectures, like the Ethereum network, implement a complete Turing machine within the algorithm virtual machine, where the system is able to process data like a real-world computer. The virtual machine executes code and instructions, and offers communication with the host machine. Turing machine completeness is accomplished with the implementation of smart contracts. Smart contracts are pieces of code executed in a decentralized fashion within each of the nodes' virtual machines, and are able to process, store and react to data inputs. Smart contracts can be affected by the blockchain state, or are able to change the blockchain state, thus changing account and node parameters and to call other smart contracts from within. Transactions on such blockchains allow transfer of tokens between accounts and/or sending funds to smart contracts in exchange for their execution.

Currently blockchain technology is mostly concerned with financial applications, to provide trustworthy transactions between parties which have not established a trusting relationship with each other. More recently, blockchain technologies have developed more complex applications enhancing their computing capacity and power towards operating as a complete Turing machine, like the Ethereum network.

Interest in blockchain structures for the Internet of Things is increasing with time. Data management is fundamental to the Internet of Things. A typical application is the collection and reporting of humidity data from sensors at a remote weather station. It is therefore important that these data are accurate. However, its adoption of blockchain technology is being inhibited by uncertainty over how the information can be trusted, and how secure are the IoT devices that are intended to be part of a distributed ledger.

Taking the example of a humidity sensor, it is essential to make sure the sensor is identified properly at the network as a humidity sensor, and that it has the correct privileges. It is also important to make sure the data submitted is correct, and that it is not using more energy than necessary to perform its tasks. Aberrations from normal operation can be indicative of an attack to the network, or just a simple fault at the sensor and its processor. It is important to ensure that IoT devices, those with low processing power, are secure, so that no unauthorized party or equipment failure can interfere with the Internet of Things infra-structure by compromising an individual node such as a sensor.

For Internet of Things applications, low processing power devices play an essential role, so it is important to minimize blockchain data processing, limiting its function to “light” node functionalities, like limiting its role on the blockchain to only device registration and data posting, for instance. In this sense, these “light” devices are more prone to be attacked or tampered with.

Some of the attacks “light” nodes can suffer on a blockchain for the Internet of Things architecture include posting inaccurate sensor data to the network, flooding the network with dumb data, or changing a device's behavior to increase its computing process to cause failure.

Currently, transactions to a blockchain are verified by the network by checking some of the fields and parameters, for example to determine if there are enough funds at the sending account to pay for the transaction, whether the computational effort (known as “gas”) allocated to the transaction will cover the entire computing processing requirements, whether the sending account exists, and if the receiving account/smart contract exists. However existing blockchain algorithms provide a limited check of transactions. The technology is efficient in determining transaction authenticity and to provide trust to the network of its existence, but little has been done to guarantee that the data used to interact to smart contracts is itself safe, as no transaction verification is made at the data, or content, level.

In the Hyperledger system the validating nodes execute a transaction code to test the network state after its execution and if the result is the same across all validating nodes, the transaction is finally updated to the blockchain.

Currently blockchain technologies are evolving from cryptographically, secure and immutable financial listed transaction records, to a complete Turing machine logic and most recently to a Direct Acyclic Graph approach where just the token transactions are present at the network, designed for scalability. The present disclosure is applicable to any of the technologies described above, wherever the concept of a decentralized ledger which to some level records transactions containing data, including n-layer architectures, where different layers serve different purposes (for instance an additional layer with peer-to-peer storage, and another as transaction interface). According to the present disclosure, there is provided distributed ledger process in which transactions between nodes in a network are posted to a distributed ledger supported by the network, and in which transaction data generated by a data node are validated by comparison with a data source of permitted transaction data types to be generated by the data node, the transaction data being posted to the distributed ledger only if it is identified as permitted. The transactions may be performed as blockchain transactions, or by using other methods such as direct acyclic graph (DAG) structures.

In an embodiment, a delay period is introduced between the creation of each transaction and the posting of that transaction to the network, and the data validation process takes place during the delay period. The validation stage may audit the transaction data as well as the authenticity of the node requesting the transaction, allowing previously authenticated nodes which have been compromised to be identified.

The checking process may be accomplished by a smart contract which both proxies the data to the intended end contract or data storage facility and checks the transaction data sent against the topics discussed before.

Alternatively, the checking process may be accomplished by a transaction explorer interface, meaning an account which is capable of reading the transactions sent through the network and providing insights on whether the data is suspicious or not.

Depending on the node in question, the types of permitted transactions may include, as a non-exhaustive list:
identification match: the size, frequency and volume of transactions expected from the node—this provides a check that a device, for example, that is identified as a sensor is actually acting as a “light” node and not querying data or performing heavy blockchain related computations
whether the node is required to only generate transactions (a sensor)
data pattern analysis: the data currently being transacted with the network is consistent to the data usually sent by this node
whether data is within expected limits (e.g. temperature sensor generating extreme values)
Other analyses related to whether the node is querying for data (calling a smart contract which holds data) if it is not usually meant to (related to an attack trying to clog the node processor, overheat it), etc.

The validation process may include various parameters of a blockchain transaction including the data field. This allows expansion of the transaction verification process of distributed ledgers.

Embodiments of the present disclosure use data within transactions to participate in the verification of the validity of the data itself, by inspection of the data field for IoT security purposes. The same data may also be used in transaction validation by using the hash of the data, or the addresses specified on that field, to compose the verification process.

The interface may take the form of a blockchain node that inspects the complete set of transactions, or only a random subset. This can be accomplished either at the current transaction check period or after the transactions have been processed, with subsequent reporting of possible malicious behavior .

The data checking method allows inspection of the transaction data content to perform a risk analysis of the content. A transaction may be overturned if it is identified as malicious.

In an embodiment of the present disclosure, the process involves some or all of the following operations. This list is not exhaustive:
a. checking the identity of the sensing account against its role at the Internet of Things system, meaning that a sensor described as a “light” node will not be able to request or process a large amount of data locally.
b. performing an inspection on the data packet size to check for an oddly large or small packets.
c. inspection of the integrity of the data, that is to say whether the data sent is consistent with the role played by the blockchain node on an IoT infrastructure. For instance, it will not accept updates every minute from a sensor that has been defined as an hourly data source. This reduces the risk of data flooding of the network.
d. inspection of the content of the data against recent data transactions sent from the same node or from similar sources to check whether this data is consistent and it is not an attempt to cause a malfunction to the system. For instance, the system would reject a temperature reading from a weather station if the data sent was significantly higher or lower than the normal range of temperatures at that location.
e. flagging malfunctioning (or targeted) devices, to alert users and/or halt participation on the network by the device. Such malfunctions may be detected by anomalous readings (as in “d” above) or by special codes indicating a malfunction.

The allocation of the data check period is not limited to certain type of mathematical modeling of the transactions queue, nor to any particular model. The method may consist of dynamically allocating a transaction data check period within the inter-block period to allow for the system to check the data sent by nodes for security, integrity and relevance. This transaction data check period can be determined based on the amount of transactions sent during the current inter-block period like a queue, in order to allow time for the majority of (if not all) transactions to be checked, depending on the system requirements. The dynamic data check period can be, as an example, determined mathematically and dynamically by taking into account the historical average time taken by the 10% lengthiest nodes as well as the amount of transactions currently queued.

### BRIEF DESCRIPTION OF DRAWINGS

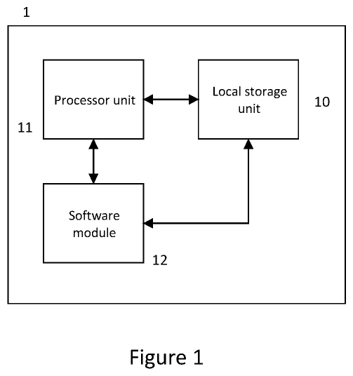

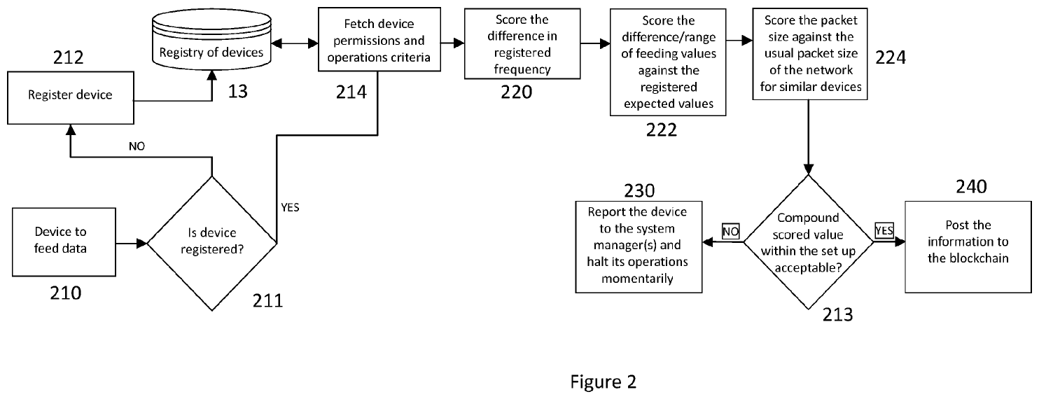

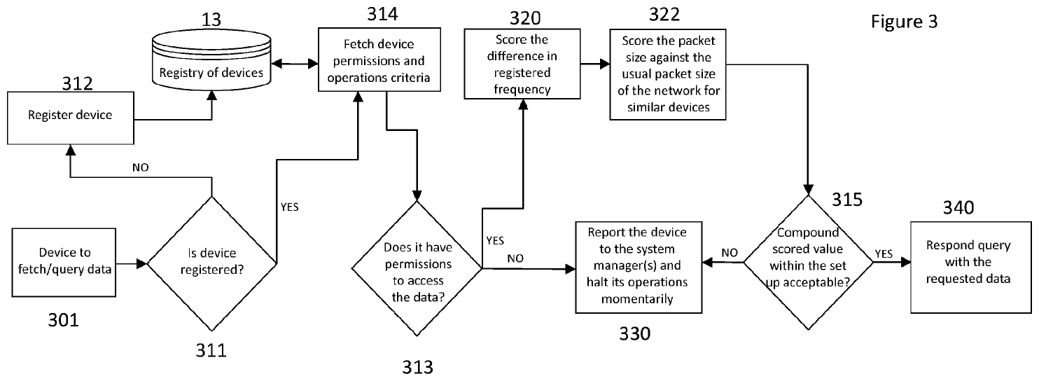

An embodiment of the present disclosure will be described by way of example with reference to the drawings accompanying this specification, in which:

[symbol] FIG. 1 illustrates the technical architecture of one of the nodes on the blockchain.

[symbol] FIG. 2 illustrates the process of the method applied to data-feeding devices.

[symbol] FIG. 3 illustrates the process of the method applied to data-querying devices.

### DETAILED DESCRIPTION

FIG. 1 depicts the technical architecture of one of the nodes on the blockchain. The embodiment may be implemented in hardware, locally, or in cloud (by the end-user connected to a remote server). If cloud is used, the cloud server implements an architecture similar to the end-user's hardware to run the blockchain. The local implementation in hardware can be executed at each node in a computer, or computer-like device 1 (for instance a micro-processor), such that the computer will be embodied on a computer readable storage medium 10 and a processing chip 11, as represented at FIG. 1. The ‘processor’ component 11 of the node is a chip capable of executing programs and producing an output in machine readable format. The ‘local storage’ component 10 is a storage medium capable of recording program and storage data and making data available to the node upon request. This is intended to store the blockchain data necessary for the processor to execute the blockchain virtual machine, and for a software maintained in a program store 12 to interact and to build applications upon the blockchain, as well as to execute software necessary to implement some realizations of the present disclosure.

The local storage component 10 may comprise one or more of the following components: RAM memory, ROM memory, SSD hard disk, floppy disk, USB disk, EPROM/EEPROM memory, registers, CD-ROM, or any other form of data and instructions storage medium known in the art. The ‘software module’ 12 stores program data including software codes both on-chain and off-chain and can be written in any language known in the art. The smart contracts of the blockchain as well as the applications built to run upon it (called decentralized applications, dapps) are maintained at this module. The smart contracts run on the blockchain virtual machine as well as the application built using it, whereas the applications used to interact with the apps are run locally by the ‘processor’ and ‘local storage’ units outside the blockchain virtual machine.

FIG. 2 is a diagram depicting a process according to an embodiment of the present disclosure for data feeding devices.

The first stage (210-214) is concerned with checking whether the device 210 attempting to feed data to the distributed ledger or database is registered at a device list 13 at the blockchain. This operation may be implemented using smart contracts or a transaction explorer interface.

If a check 211 identifies that the device is not registered, a registration process takes place 212). The registration process involves a number of operations that have to be completed in order for the process to work accordingly. During the registration process, the device is catalogued with relevant data for this method such as, for example, the designed frequency of data update, the range of meaningful values, the usual data packet committed, amongst other data that the system administrator may find useful. This data cataloguing is performed with input from a system manager.

For both newly-registered and already-registered devices, data relating to the device is then loaded from the registry (214). The next operations are to process any checks and score the blockchain data (220 to 224). The operations illustrated here are examples only, and the nature and number of checks, and the score awarded to the data, are determined by the system manager upon registration (212).

The transaction data check may include, in a non-exhaustive list:
Check of the device identity against its role on the IoT system
Committing data more frequently than usual (220), which may indicate malicious sending of dumb data
Failure on data values committed (222)
Checks whether the device's registered identification accords to the pattern of data it is sending, for example committing more or less data within packets than specified (224)
Checks to identify malfunctions of the devices (either a special malfunction code, or by implication from anomalous data reports)

The operations represented in FIG. 2 are thus indicative of the type of checks that may be required to protect the IoT blockchain architecture against blockchain data related issues, and more, fewer, or different tests may be applied to suit the circumstances of the purpose for which the blockchain transactions are to take place.

Firstly, a scoring process 220 is performed, aimed at scoring low grades to devices that are attempting to post more or less frequently than they were registered for. Operation 222 scores low grades for devices posting data outside a range of values previously specified for the device, for instance it would award low grades to town center temperature sensors feeding a measure of 300C. Operation 224 inspects the data packet size being committed, and would award low grades to packets larger than a previously-registered value.

After these checks, comparisons and scorings, the method would collate the results and compare the final result with a score previously determined as acceptable (213). If it passes the score, the data provided by the device gets posted to the distributed ledger or database (240). If it fails, the transaction is not processed by the blockchain, and the device is reported to the system manager and its operations at the blockchain are halted for a certain period of time (230).

FIG. 3 is a diagram depicting a process according to an embodiment of the present disclosure for data querying devices.

The first stage (301-314) is concerned with checking whether the device 301 willing to query data at the distributed ledger or database is registered at a distributed ledger 13 of identified devices. This operation may be implemented using smart contracts or a transaction explorer interface. If a check (311) identifies that the device is not registered, then a registration process takes place (312). The registration process involves a number of operations that have to be completed in order for the process to work accordingly. During the registration process, the device is catalogued with relevant information for this method such as, for example, the designed frequency of data querying and the allowed datasets, amongst other data that a system manager may find useful.

For both newly-registered and already-registered devices, data relating to the device is then loaded from the registry (314). The next operations are to process any checks and score the blockchain data (313, 320, 322). The operations illustrated here are examples only, and the nature and number of checks and the scores awarded to the data are determined by the system manager upon registration (312). The operations represented at FIG. 3 are thus indicative of the type of check that may be required to protect the IoT blockchain architecture against blockchain data related issues and more, fewer, or different tests may be applied to suit the circumstances of the purpose for which the blockchain transactions are to take place.

An initial operation 313 is concerned with access authorization , and checks the device ID against a record of access rights to determine if the device is permitted access to certain datasets. This may aid identification of malicious attempts to pull data from the blockchain which is not generally relevant to the device function.

If it fails to have proper access authorization , the transaction is rejected at the blockchain, the device is automatically reported to the system manager (330) and the device may be prevented from querying the system again until a prescribed period of time has elapsed.

If the device passes this initial test, a scoring process (320) is next performed. This scores low grades to devices that are attempting to query data at a rate significantly different (more or less frequent) than that for which they were registered.

The next operation 322 checks the data packet size with a previously determined expected size, and with previous data packets sent by the same node, and scores it accordingly. This allows a check whether the device registered identification accords to the pattern of data it is receiving, or attempting to receive, for example committing more or less data within packets than specified.

After the rounds of checks, comparisons and scorings, the results are collated and the final score compared (315) with a score previously determined by the system manager as acceptable. If it passes the score, the device is provided with the data it requested (340). If it fails, the transaction is overturned, the device is reported to the system manager (330) and the device may be prevented from querying the system again until a prescribed period of time has elapsed.

The processes depicted in FIG. 2 and FIG. 3 can be implemented in various ways. Both embodiments may be implemented entirely using smart contracts, including the verifications and scoring processes, the reporting of faulty or malicious devices and the feeding of the information. Another possible implementation is to use a locally stored program at one of the trusted nodes of the network, co-operating with libraries able to interact with the blockchain, or any other algorithm that can process data and interact with distributed ledgers. This piece of code would be invoked by a smart contract within the blockchain, and upon the completion of this local program another smart contract would be invoked to either report the device or to post the data/respond query.

A lighter version can be implemented, in which there is a trusted node in the network to perform the checks and scoring during normal execution of the blockchain, without interfering with the normal, pre-determined, data check period specified by the system consensus algorithm. This embodiment may be easily implemented to already-deployed systems, but as it takes place in parallel with execution of the blockchain, instead of beforehand, the effectiveness of the data checks is reduced as the data integrity check may occur after the post/query has been executed. The principles of the process remain the same, as the process can still report compromised devices and, if necessary, prevent a device found to have been compromised continuing to have access to the system. Such an arrangement is suitable for circumstances in which the reduced data check period is sufficiently advantageous to overcome the effects of individual examples of rogue data being executed before detection and remedial action to prevent a recurrence.

Another possible application of this method can be within the blockchain protocol. To date, the transactions verifications only verify funds of the sender account, existence of destination address, and nonce counting. Including a data check policy within the blockchain protocol will enhance the security for IoT systems reliant on blockchain. This scenario might include the dynamically allocated data-check period described earlier on, and if so will effectively create a new consensus protocol.

There follows an example of the check and scoring system. This provides operations that compute the ratio of the current parameter submitted to a specified expected value of that parameter. Examples of such parameters include the frequency of posting/querying, sensor data provided, data packet length.

In this example, it is assumed the device is already properly registered, so the method fetches information about the device registration to begin the check.

The scoring system is based on the comparison of the updating rate and the difference between a reported value and the range in which that value is expected to lie. A “division distance” is calculated as the ratio of the actual value to the expected value, or to the closest value within the expected range of values. The “division distance” is calculated such that its value is greater than or equal to 1—that is to say, the actual value and expected value are selected to be numerator and denominator respectively, depending on which has the larger absolute value. The division distances may be weighted for their significance, and then added to generate a score which, in this example, is subtracted from 100.

In the present example, the expected frequency of updates (set by the system administrator) is once every minute ( 1/60 per second), an expected range of temperature values lies between −10 C and 35 C, the update frequency is weighted to be half as important as the temperature score, and the acceptable minimum score set by the system administrator is 70.

If the sensor commits a value of 238 C, and the actual frequency of reports, based on the past three commits, is once every second (1 per second).
Division distance for reporting rate=1/ 1/60=60 (meaning it is posting 60 times more frequently that it was supposed to be). Weighted value is ½×60=30.
Division distance for reported value 238/35=6.7.
Score after these two steps=100−30−6.7=63.3

Since this score is less than the value of 70 set by the administrator as acceptable, this transaction will be rejected by the blockchain, the device will be flagged to the system manager and its operation suspended.

A simpler example can also include a sub-set of an IoT system which includes a humidity sensor coupled with other sensors, including various rains sensors. If the expected frequency of updates on this case is once every minute and the expected range of values is between 20% and 80%, unless it is raining and then the systems allows humidity values of up to 100%. The humidity score is five times more important than the frequency score in this case and the acceptable minimum score set by the system administrator is 80. The humidity score is calculated using the average, or expected value, of the variable, where it is 50%

If it does not rain and the sensor commits a value of 89%, and the actual frequency of reports, based on the past four commits, is once every four seconds (15 per minute).
Division distance for reporting rate=1/ 1/15=15 (meaning it is posting 15 times more frequently that it was supposed to be).
Division distance for reported value 89/50=1.78. Weighted value 1.78×5=8.9
Score after these two steps=100−15−8.9=76.1

Since this score is less than the value of 80 set by the administrator as acceptable, this transaction will be rejected by the blockchain, the device will be flagged to the system manager and its operation suspended.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A distributed ledger process comprising:
posting transactions between nodes in a network to a distributed ledger supported by the networks;
validating transaction data generated in respect of a data node by comparison with a data source of permitted transaction data types to be generated in respect of the data node, the transaction being posted to the distributed ledger only if the transaction data is identified as permitted.

2. The distributed ledger process according to claim 1, wherein the transactions are performed as blockchain transactions.

3. The distributed ledger process according to claim 1, wherein the transactions are performed using directed acyclic graph (DAG) structures.

4. The distributed ledger process according to claim 1, further comprising:
introducing a delay period between a creation of a respective transaction and the posting of the respective transaction to the network, wherein the data validation process takes place during the delay period.

5. The distributed ledger process according to claim 1, wherein a blockchain transaction is validated after the transaction has been processed, the process further comprising:
reporting any invalid transaction to a control system to manage subsequent operation of nodes that have generated or responded to such invalid transactions.

6. The distributed ledger process according to claim 5, in which invalid transactions are reversed in a subsequent transaction.

7. The distributed ledger transaction process according to claim 1, wherein validating further includes a check on the size, frequency and number of transactions expected from the data node.

8. The distributed ledger transaction process according to claim 1, wherein validating further includes a check on the whether the data node is expected to generate or monitor transactions.

9. The distributed ledger process according to claim 1 wherein validating further comprises conducting data pattern analysis to determine whether the transaction data currently being transacted by the data node is consistent with data expected to be sent by the node.

10. The distributed ledger process according to claim 1, wherein validating further includes a determination of whether values of the transaction data are within predetermined limits.

11. The distributed ledger process according to claim 1, wherein validating further includes a determination of whether the data node is permitted to generate data, or to retrieve data by calling smart contracts which hold data.

12. The distributed ledger process according to claim 1, wherein the check is performed by a smart contract which both proxies the data to an end contract or a data storage facility and performs the validating.

13. The distributed ledger process according to wherein the check is performed by a transaction explorer interface.

14. An apparatus configured to perform a method according to claim 1.

15. A computer program element comprising computer program code to, when loaded into a computer system and executed thereon, cause the computer to perform the steps of a method as claimed in claim 1.
